(19) United States
(12) Patent Application Publication
(10) Pub. No.: US 2018/0285849 A1
(43) Pub. Date: Oct. 4, 2018

(54) PRODUCT AUTHENTICATION METHOD AND SYSTEM THEREOF

(71) Applicant: Weng Wah Chng, Singapore (SG)

(72) Inventor: Weng Wah Chng, Singapore (SG)

(21) Appl. No.: 15/476,064

(22) Filed: Mar. 31, 2017

(51) Int. Cl. G06Q 20/20; G06Q 20/40

(52) U.S. Cl. CPC G06Q 20/206; G06Q 20/4014

(57) ABSTRACT

The disclosure is related to a product authentication method including obtaining object information having a first object code and a second object code from a machine-readable graphic code of an object; generating an authentication code corresponding to the obtained object information; generating transaction information comprising the authentication code, and marking a flag in relation to the object in a database; generating a time stamp when the transaction information is generated; and authenticating the validity of the object according to the time stamp and the flag using the authentication code.

### CROSS REFERENCE TO RELATED APPLICATIONS

This application is being filed concurrently with U.S. Ser. No. ______, entitled POS TRANSACTION METHOD AND SYSTEM, attorney Docket No. 160316PS.0.1-US/COH 005PA; U.S. Ser. No. ______, entitled METHOD FOR ACTIVATING AN OBJECT AND TERMINAL DEVICE THEREOF, attorney Docket No. 160316PS.3.1-US/COH005PA3; and U.S. Ser. No. ______, entitled PRODUCT AUTHENTICATION METHOD AND SYSTEM THEREOF, attorney Docket No. 160316PS.2.1-US/COH005PA4, the entire disclosures of which are incorporated by reference herein.

### BACKGROUND

### Technical Field

The disclosure is related to a transaction method and system, and more particular to a POS transaction method and system.

### Related Art

In general, in order to avoid the product being stolen, most stores may use the security induction magnetic stripe disposed on the product. Before the security induction magnetic stripe is not demagnetized, the product equipped with security induction magnetic stripe passes through the sensor, an alarm of the sensor may sound to alert the store, such that store may know the product being stolen.

However, if the sensor is failure or the product is still stolen successfully, the stolen product can still be used and operated normally. Therefore, the existing security mechanism is still required to be improved.

In other situations, someone may intend to return stolen product to the seller. If the seller does not have database to identify whether the product is sold or not, the seller would spend unnecessary expense for the return product as the stolen product does not generate any sales income.

### SUMMARY

The disclosure provides a product authentication method, which includes the following steps: obtaining object information having a first object code and a second object code from a machine-readable graphic code of an object; generating an authentication code corresponding to the obtained object information; generating transaction information comprising the authentication code, and marking a flag in relation to the object in a database; generating a time stamp when the transaction information is generated; and authenticating the validity of the object according to the time stamp and the flag using the authentication code.

The disclosure provides a product authentication system, comprising: a processor and a memory for storing one or more instructions; wherein when the one or more instructions are executed by the processor, the processor executes the following steps: obtaining object information having a first object code and a second object code from a machine-readable graphic code of an object; generating an authentication code corresponding to the obtained object information; generating transaction information comprising the authentication code, and marking a flag in relation to the object in a database; generating a time stamp when the transaction information is generated; and authenticating the validity of the object according to the time stamp and the flag using the authentication code.

It should be understood, however, that this summary may not contain all aspects and embodiments of the present invention, that this summary is not meant to be limiting or restrictive in any manner, and that the invention as disclosed herein will be understood by one of ordinary skill in the art to encompass obvious improvements and modifications thereto.

### BRIEF DESCRIPTION OF THE DRAWINGS

The above and other exemplary aspects, features and advantages of certain exemplary embodiments of the present disclosure will be more apparent from the following description taken in conjunction with the accompanying drawings, in which:

FIG. 1 is a flowchart of a POS transaction method according to a first embodiment of the present disclosure.

FIG. 2 is a flowchart of a POS transaction method according to a second embodiment of the present disclosure.

FIG. 3 is a schematic view of a POS transaction system according to a third embodiment of the present disclosure.

FIG. 4 is a flowchart of a product authentication method according to another embodiment of the present disclosure.

FIG. 5 is a flowchart of the authenticating step of the product authentication method shown in FIG. 4.

FIG. 6 is a flowchart of a product authentication method according to another embodiment of the present disclosure.

FIG. 7 is a flowchart of the authenticating step of the product authentication method shown in FIG. 6.

FIG. 8 is a schematic view of the product authentication system according to another embodiment of the present disclosure.

### DETAILED DESCRIPTION

The present invention will now be described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” or “has” and/or “having” when used herein, specify the presence of stated features, regions, integers, steps, operations, elements, and/or components, but do not preclude the presence or addition of one or more other features, regions, integers, steps, operations, elements, components, and/or groups thereof.

It will be understood that the term “and/or” includes any and all combinations of one or more of the associated listed items. It will also be understood that, although the terms first, second, third etc. may be used herein to describe various elements, components, regions, parts and/or sections, these elements, components, regions, parts and/or sections should not be limited by these terms. These terms are only used to distinguish one element, component, region, part or section from another element, component, region, layer or section. Thus, a first element, component, region, part or section discussed below could be termed a second element, component, region, layer or section without departing from the teachings of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

The following description with reference to the accompanying drawings is provided to explain the exemplary embodiments of the disclosure. Note that in the case of no conflict, the embodiments of the present disclosure and the features of the embodiments may be arbitrarily combined with each other.

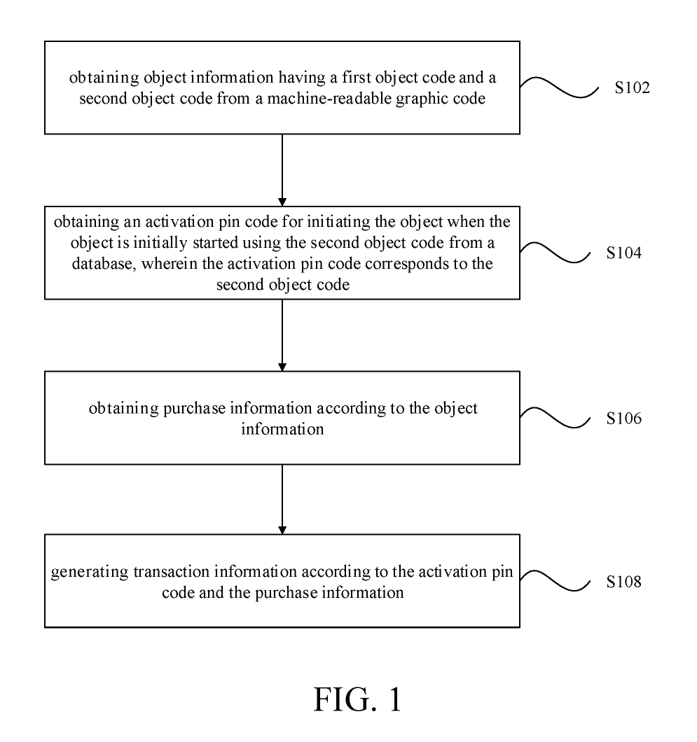

FIG. 1 is a flowchart of a POS transaction method according to a first embodiment of the present disclosure. Please refer to FIG. 1, in step S102, the method involves obtaining object information having a first object and a second object code from a machine-readable graphic code. In the embodiment, the first object code refers to object message, which may include, for example, type, scale, manufacture, model number, serial number, etc., and the first object code is provided by a supplier of the object. The second object code may be, for example, generated according to the first object code and the second object code may be, for example, a linking index. The object information may be, for example, a combination of the first object code and the second object code. To be more specific, the first object code may be sent from the supplier of the object. A third party, that is not the supplier, may generate a second object code corresponding to the first object code. Then the supplier, or the third party may combine the first object code and the second object code to generate the object information. Then the object information having the first object code and the second object code may be formed as a machine-readable graphic code, which may be printed on a label to be further attached on the object.

In step S104, an activation pin code for initiating the object when the object is initially started using the second object code from a database is obtained, wherein the activation pin code corresponds to the second object code. For example, when the second object code is obtained, the second object code is used obtain the activation pin code from the database in the server, and then the activation pin code corresponding to the second object code may be obtained from the database. In one embodiment, the activation code may also be, for example, a predetermined code produced by a third party, which is not a supplier of the object. In addition, the object may be, for example, electronic products, such as, television, tablet computer, laptop computer, etc.

In one embodiment, the machine-readable graphic code may be a 2D code. An optoelectronically readable 2D code or 2D barcode for example is therefore used, which consists of lines or dots of differing widths with gaps in between. The data of the object messages is encoded in the form of an area over two dimensions, which allows a higher information density to be achieved per unit of area. Such codes can be read in using a corresponding reader configured in the POS system.

In one advantageous embodiment of the disclosure the machine-readable graphic code may be arranged in matrix form, one-dimensionally in a number of rows or in circles. The codes used can be for example stacked codes such as Codablock, code 49, PDF417 or matrix codes such as QR code, DataMatrix, MaxiCode, Aztec code.

In step S106, the method involves obtaining purchase information according to the object information. For, example, the object information may be scanned by a barcode machine to obtain the purchase information. In the embodiment, the purchase information may be, for example, includes at least a purchase time and/or a purchase date associated with the object. In another embodiment, the purchase information further includes the retailer information associated with the object.

In step S108, the method involves generating transaction information according to the activation pin code and the purchase information. Therefore, the transaction information may include the activation pin code and the purchase information, and the activation pin code may be unique and matched with the purchase information, such that the user may use the activation pin code included in the transaction information to start the object and operate the object normally, so as to avoid the risk of theft of the object, thereby increasing the safety of the object.

It should be noted that if the user does not purchase the object, the user may not get the activation pin code included in the transaction information, such that the user may not start the object and may not operate the object normally, so as to avoid the risk of theft of the object, thereby increase the safety of the object.

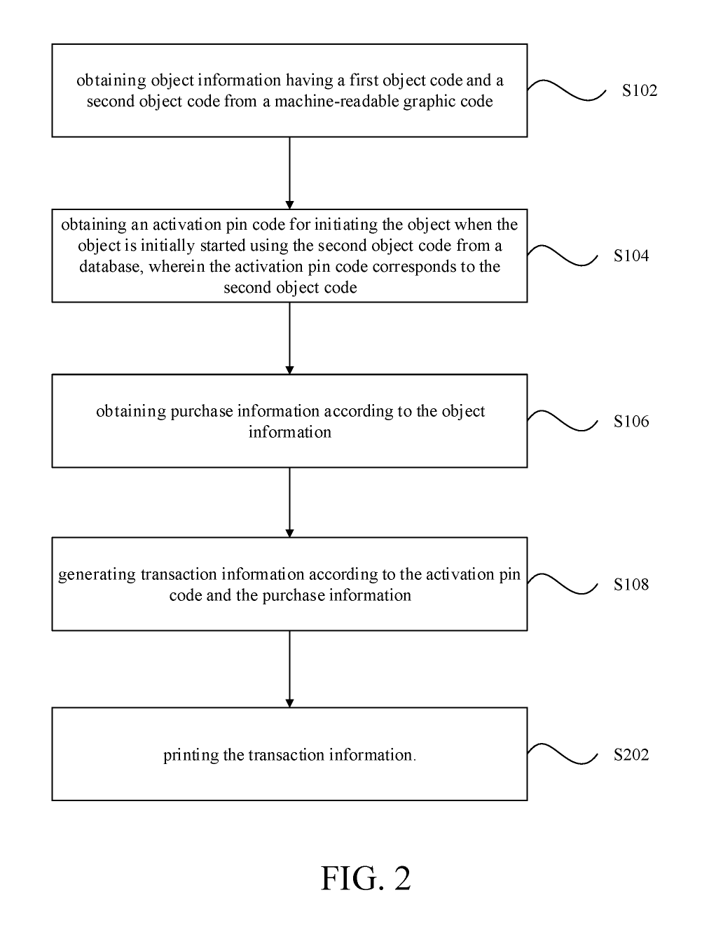

FIG. 2 is a flowchart of a POS transaction method according to a second embodiment of the present disclosure. In the embodiment, the steps S102, S104, S106 and S108 in FIG. 2 are similar to the steps S102, S104, S106 and S108 in the embodiment of FIG. 1, the description may refer to the embodiment of the FIG. 1, thus the description thereof is omitted.

Please refer to FIG. 2, in step S202, the method involves the printing the transaction information by a third party, which is not a supplier of the object. For example, the transaction information may be, for example, printed on a receipt by a third party, which is not a supplier of the object, such that the user may easily see the transaction information on the receipt, and input the activation pin code to the object to start the object and operate the object normally, thereby increasing the convenience for the user.

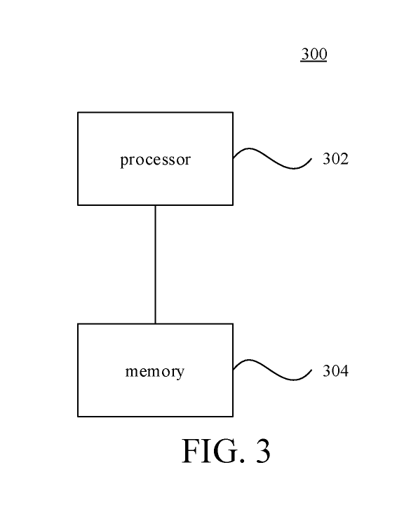

FIG. 3 is a schematic view of the POS transaction system according to a third embodiment of the present disclosure. Please refer to FIG. 3, the POS transaction system 300 includes a processor 302 and a memory 304. The memory 304 communicates with the processor 302, and is used to store one or more instructions.

In addition, when the one or more instructions are executed by the processor 302, the processor 302 may execute the steps S102, S104, S106 and S108 of FIG. 1 or the steps S102, S104, S106, S108 and S202 of FIG. 2. The description of the steps S102, S104, S108 and S108 of FIG. 1 and the steps S102, S104, S106, S108 and S202 of FIG. 2 may respectively refer to the embodiments of FIG. 1 and FIG. 2, thus the description thereof is omitted. In this embodiment, it may also increase the safety of the object.

In summary, the POS transaction method and system provided by the present disclosure firstly obtains the object information having a first object code and a second object code from a machine-readable graphic code, obtains an activation pin code for initiating the object when the object is initially started using the second object code from a database, obtains the purchase information according to the object information, and then generates the transaction information according to the activation pin code and the purchase information. That is, if the user does not complete the purchase of the object, the user does not obtain the transaction information and the activation pin code, such that the user may not start the object and may not operate the object normally. Therefore, the present disclosure may effectively avoid the risk of theft of the object, thereby increasing the safety of the object.

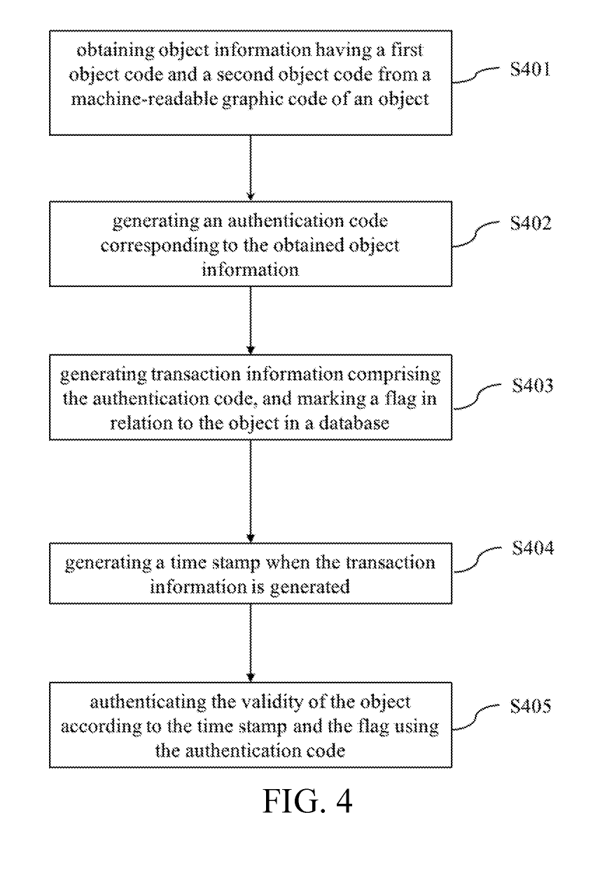

FIG. 4 is a flowchart of a product authentication method according to another embodiment of the present disclosure. This embodiment illustrates the process about how to authenticate a product sold. In Step S401, the method involves obtaining a first code having object information and a second code corresponding to the first code. In this embodiment, the first object code refers to object message, which may include, for example, type, scale, manufacture, model number, serial number, etc., and the first object code is provided by a supplier of the object. The object may be a product sold in a retailer or a store, or a drug. The second object code may be, for example, generated according to the first object code and the second object code may be a code provided from a third party other than the supplier. To be more specific, the first object code may be sent from the supplier of the object. A third party, that is not the supplier, may generate a second object code corresponding to the first object code. Then the supplier, or the third party may combine the first object code and the second object code to generate the object information. Then the object information having the first object code and the second object code may be generated as a machine-readable graphic code, which may be printed on a document or a transaction receipt. Alternatively, this graphic code may also be printed on a label to be further attached on the object.

After the step S401, the method involves generating an authentication code corresponding to the obtained object information (step S402). A user or a buyer may use this authentication code to verify the authentication state. After the authentication code is generated, the method then involves generating transaction information comprising the authentication code (step S403). The transaction information may then be printed on a paper receipt, or may be generated as an electronic file. The authentication state indicates the validity of the object. If the sold product is not valid or is not from the store, the authentication state would indicate invalidity.

After the transaction information is generated, the method further involves marking a flag in relation to the object in a database to indicate whether the object is sold or not. Then a time stamp is generated when the transaction information is generated (step S404). The time stamp indicates the time that the product is sold.

The above steps of the method are executed in a transaction apparatus, such as a POS system or an online shopping server. After the product is sold, the buyer may use the authentication code to verify the authentication state. Therefore, an authenticating step for authenticating the validity of the object according to the time stamp and the flag using the authentication code is then executed (step S404). The authentication would fail if the result of the authenticating step indicates invalidity of the object. Either the invalidity of the authentication state or the not-sold state of the flag would result in authentication failure.

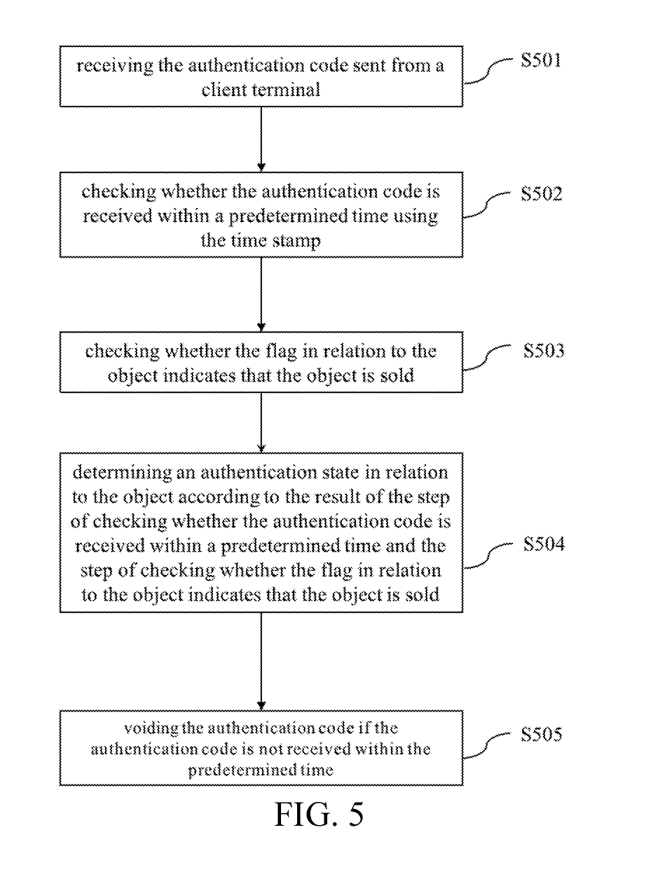

FIG. 5 is a flowchart of the authenticating step of the product authentication method shown in FIG. 4. When the buyer intends to complete the authenticating process, he or she may refer to the authentication code and uses a client terminal such as a mobile phone or a computer to send the authentication code. A remote device such as a server would then execute the authenticating step after the authentication code sent from a client terminal is received (step S501). A time stamp in association with the object is generated when the transaction information is generated. The time stamp is used to calculate the period from the time the product is sold to the time the authentication code is received. Thus, a step for checking whether the authentication code is received within a predetermined time using the time stamp is executed (step S502). The authenticating step would fail if the code is not received within a predetermined time, for example, 48 hours from the product is sold.

Then a step for checking whether the flag in relation to the object indicates that the object is sold is executed (step S503). If the flag indicates that the product is not sold, even though the code is received within a predetermined time, the authenticating step would also fail.

The method would then determine an authentication state in relation to the object according to the result of the step of checking whether the authentication code is received within a predetermined time and the step of checking whether the flag in relation to the object indicates that the object is sold (step S504).

The authentication state may be determined as follows. If the authentication code is received within a predetermined time and the flag in relation to the object indicates that the object is sold, the authentication state would indicate the validity of the object. If the authentication code is received within a predetermined time but the flag in relation to the object indicates that the object is not sold, the authentication state would indicate the invalidity of the object. If the authentication code is received over the predetermined time, the authenticating step would fail.

In one embodiment, the authentication code is voided if the authentication code is not received within the predetermined time (step S505).

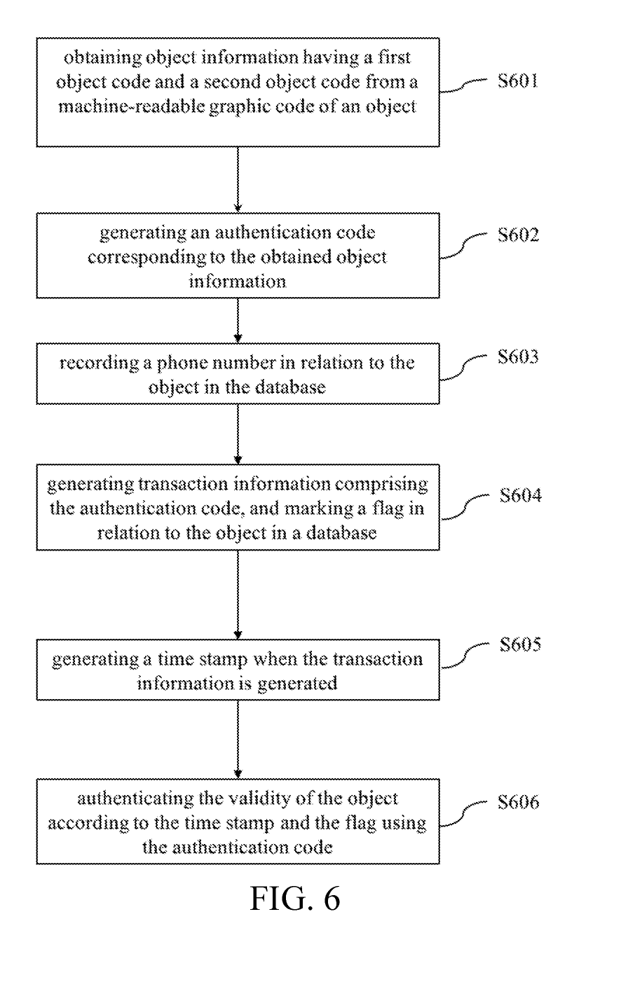

FIG. 6 is a flowchart of a product authentication method according to another embodiment of the present disclosure.

This embodiment illustrates the process about how to authenticate a product sold. In Step S601, the method involves obtaining a first code having object information and a second code corresponding to the first code. In this embodiment, the first object code refers to object message, which may include, for example, type, scale, manufacture, model number, serial number, etc., and the first object code is provided by a supplier of the object. The object may be a product sold in a retailer or a store, or a drug. The second object code may be, for example, generated according to the first object code and the second object code may be a code provided from a third party other than the supplier. To be more specific, the first object code may be sent from the supplier of the object. A third party, that is not the supplier, may generate a second object code corresponding to the first object code. Then the supplier, or the third party may combine the first object code and the second object code to generate the object information. Then the object information having the first object code and the second object code may be generated as a machine-readable graphic code, which may be printed on a document or a transaction receipt. Alternatively, this graphic code may also be printed on a label to be further attached on the object.

Then the process involves receiving and recording a phone number in relation to the object in the database (step S602). The phone number may be the buyer's home number or mobile phone number.

After the step S602, the method involves generating an authentication code corresponding to the obtained object information (step S603). A user or a buyer may use this authentication code to verify the authentication state. After the authentication code is generated, the method then involves generating transaction information comprising the authentication code (step S604). The transaction information may then be printed on a paper receipt, or may be generated as an electronic file. The authentication state indicates the validity of the object. If the sold product is not valid or is not from the store, the authentication state would indicate invalidity.

After the transaction information is generated, the method further involves marking a flag in relation to the object in a database to indicate whether the object is sold or not. Then a time stamp is generated when the transaction information is generated (step S605). The time stamp indicates the time that the product is sold.

The above steps of the method are executed in a transaction apparatus, such as a POS system or an online shopping server. After the product is sold, the buyer may use the authentication code to verify the authentication state. Therefore, an authenticating step for authenticating the validity of the object according to the time stamp and the flag using the authentication code is then executed (step S606). The authentication would fail if the result of the authenticating step indicates invalidity of the object. Either the invalidity of the authentication state or the not-sold state of the flag would result in authentication failure.

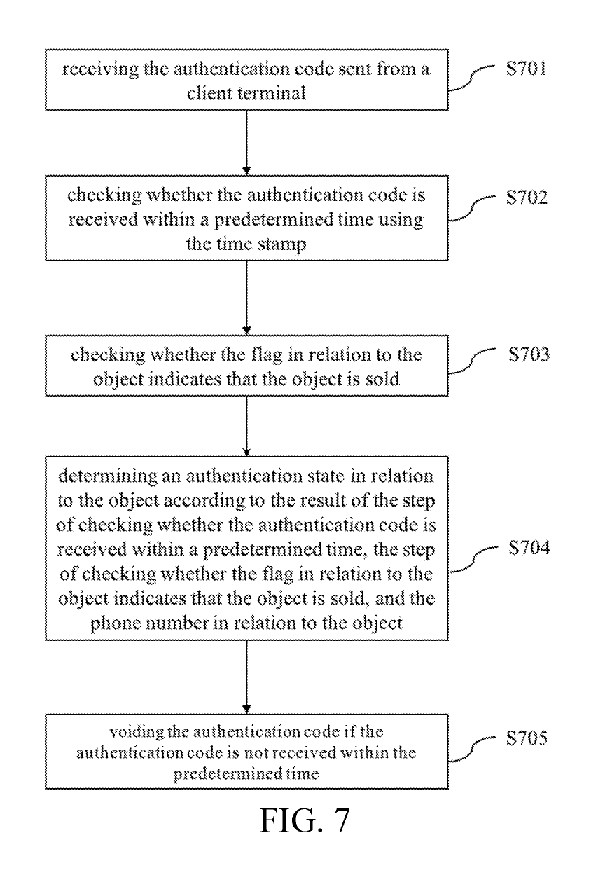

FIG. 7 is a flowchart of the authenticating step of the product authentication method shown in FIG. 6. When the buyer intends to complete the authenticating process, he or she may refer to the authentication code and uses a client terminal such as a mobile phone or a computer to send the authentication code. A remote device such as a server would then execute the authenticating step after the authentication code and the phone number sent from a client terminal is received (step 701). A time stamp in association with the object is generated when the transaction information. The time stamp is used to calculate the period from the time the product is sold to the time the authentication code is received. Thus, a step for checking whether the authentication code is received within a predetermined time using the time stamp is executed (step S702). The authenticating step would fail if the code is not received within a predetermined time, for example, 48 hours from the product is sold.

Then a step for checking whether the flag in relation to the object indicates that the object is sold is executed (step S703). If the flag indicates that the product is not sold, even though the code is received within a predetermined time, the authenticating step would also fail.

The method would then determine an authentication state in relation to the object according to the result of the step of checking whether the authentication code is received within a predetermined time, the step of checking whether the flag in relation to the object indicates that the object is sold, and the phone number in relation to the object (step S704).

The authentication state may be determined as follows. If the authentication code is received within a predetermined time, the flag in relation to the object indicates that the object is sold, and the received phone number matches with the recorded phone number, the authentication state would indicate the validity of the object. If the authentication code is received within a predetermined time but the flag in relation to the object indicates that the object is not sold or the received phone number does not match with the recorded phone number, the authentication state would indicate the invalidity of the object. If the authentication code is received over the predetermined time, the authenticating step would fail.

In one embodiment, the authentication code is voided if the authentication code is not received within the predetermined time (step S705).

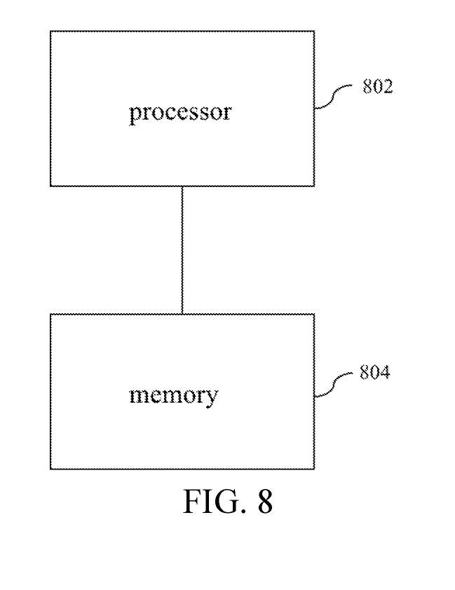

FIG. 8 is a schematic view of the product authentication system according to another embodiment of the present disclosure. Please refer to FIG. 9, the POS transaction system 800 includes a processor 802 and a memory 804. The memory 804 communicates with the processor 802, and is used to store one or more instructions.

In addition, when the one or more instructions are executed by the processor 802, the processor 802 may execute the steps of FIG. 4 and FIG. 5 or the steps of FIG. 6 and FIG. 7. The description of the steps of FIG. 4 and FIG. 5 or the steps of FIG. 6 and FIG. 7 may respectively refer to the embodiments mentioned above, and thus the description thereof is omitted.

It will be appreciated for those having ordinary skills in the related art that all or part of the above method may be accomplished by a program instructing related hardware. The program may be stored in a computer-readable storage medium, such as read-only memory, a hard disk or CD-ROM. Alternatively, all or part of the steps of the above-described embodiments may be accomplished by one or more integrated circuits. Accordingly, each module in the above-described embodiments may be accomplished by hardware implementation, or may also be realized by the form of software modules. The present disclosure is not limited to any particular form of combination of software and hardware.

Any of the operations described herein that form part of the invention are useful machine operations. The invention also relates to a device or an apparatus for performing these operations. The apparatus may be specially constructed for the required purposes, or it may be a general-purpose computer selectively activated or configured by a computer program stored in the computer. In particular, various general-purpose machines may be used with computer programs written in accordance with the teachings herein, or it may be more convenient to construct a more specialized apparatus to perform the required operations.

The invention can also be embodied as computer readable code and/or logic on a computer readable medium. The computer readable medium is any data storage device that can store data which can thereafter be read by a computer system. Examples of the computer readable medium include hard drives, network attached storage (NAS), logic circuits, read-only memory, random-access memory, CD-ROMs, CD-Rs, CD-RWs, magnetic tapes, and other optical and non-optical data storage devices. The computer readable medium can also be distributed over a network coupled computer systems so that the computer readable code is stored and executed in a distributed fashion.

It will be further appreciated that the instructions represented by the operations in the above figures are not required to be performed in the order illustrated, and that all the processing represented by the operations may not be necessary to practice the invention. Further, the processes described in any of the above figures can also be implemented in software stored in any one of or combinations of the RAM, the ROM, or the hard disk drive.

Finally, it should be noted that the above embodiments are merely provided for describing the technical solutions of the disclosure, but not intended to limit the disclosure. Although reference to the embodiments of the disclosure has been described in details, those skilled in the art will appreciate that the technical solutions described in the foregoing embodiments can be modified, or equivalently replaced for some technical features; and such modifications or replacements do not make the essence of the corresponding technical solutions depart from the spirit and scope of the technical implementation of the disclosure.

Although the present disclosure is illustrated and described with reference to specific embodiments, those skilled in the art will understand that many variations and modifications are readily attainable without departing from the spirit and scope thereof as defined by the appended claims and their legal equivalents.

What is claimed is:

1. A product authentication method, comprising:
obtaining object information having a first object code and a second object code from a machine-readable graphic code of an object;
generating an authentication code corresponding to the obtained object information;
generating transaction information comprising the authentication code, and marking a flag in relation to the object in a database;
generating a time stamp when the transaction information is generated; and
authenticating the validity of the object according to the time stamp and the flag using the authentication code.

2. The method according to claim 1, wherein the authenticating step comprises:
receiving the authentication code sent from a client terminal;
checking whether the authentication code is received within a predetermined time using the time stamp;
checking whether the flag in relation to the object indicates that the object is sold; and
determining an authentication state in relation to the object according to the result of the step of checking whether the authentication code is received within a predetermined time and the step of checking whether the flag in relation to the object indicates that the object is sold.

3. The method according to claim 2, further comprising:
voiding the authentication code if the authentication code is not received within the predetermined time.

4. The method according to claim 1, further comprising:
recording a phone number in relation to the object in the database.

5. The method according to claim 4, wherein the authenticating step comprises:
receiving the authentication code sent from a client terminal;
checking whether the authentication code is received within a predetermined time using the time stamp;
checking whether the flag in relation to the object indicates that the object is sold; and
determining an authentication state in relation to the object according to the result of the step of checking whether the authentication code is received within a predetermined time, the step of checking whether the flag in relation to the object indicates that the object is sold, and the phone number in relation to the object.

6. The method according to claim 5, further comprising:
voiding the authentication code if the authentication code is not received within the predetermined time.

7. A product authentication system, comprising:
a processor;
a memory for storing one or more instructions;
wherein when the one or more instructions are executed by the processor, the processor executes the following steps:
obtaining object information having a first object code and a second object code from a machine-readable graphic code of an object;
generating an authentication code corresponding to the obtained object information;
generating transaction information comprising the authentication code, and marking a flag in relation to the object in a database;
generating a time stamp when the transaction information is generated; and
authenticating the validity of the object according to the time stamp and the flag using the authentication code.

8. The method according to claim 7, wherein the processor is further configured for:
receiving the authentication code sent from a client terminal;
checking whether the authentication code is received within a predetermined time using the time stamp;
checking whether the flag in relation to the object indicates that the object is sold; and
determining an authentication state in relation to the object according to the result of the step of checking whether the authentication code is received within a predetermined time and the step of checking whether the flag in relation to the object indicates that the object is sold.

9. The method according to claim 8, wherein the processor is further configured for:
voiding the authentication code if the authentication code is not received within the predetermined time.

10. The method according to claim 7, wherein the processor is further configured for:
recording a phone number in relation to the object in the database.

11. The method according to claim 10, wherein the processor is further configured for:
receiving the authentication code and the phone number sent from a client terminal;
checking whether the authentication code is received within a predetermined time using the time stamp;
checking whether the flag in relation to the object indicates that the object is sold; and
determining an authentication state in relation to the object according to the result of the step of checking whether the authentication code is received within a predetermined time, the step of checking whether the flag in relation to the object indicates that the object is sold, and the phone number in relation to the object.

12. The method according to claim 11, wherein the processor is further configured for:
voiding the authentication code if the authentication code is not received within the predetermined time.
